(19) United States
(12) Patent Application Publication
(10) Pub. No.: US 2012/0246581 A1
(43) Pub. Date: Sep. 27, 2012

(54) MECHANISMS TO SHARE OPINIONS ABOUT PRODUCTS

(75) Inventors: Ulla-Maaria Engestrom, Helsinki (FI); Janne Jalkanen, Espoo (FI)

(73) Assignee: THINGLINK OY, Helsinki (FI)

(21) Appl. No.: 13/429,900

(22) Filed: Mar. 26, 2012

Related U.S. Application Data
(60) Provisional application No. 61/467,076, filed on Mar. 24, 2011.

(51) Int. Cl. G06F 3/01

(52) U.S. Cl. 715/753

(57) ABSTRACT

A method includes reading data from a tag of a physical item over a short range communication connection, using the data read from the tag to obtain information associated with the physical item, displaying to a user the obtained information associated with the physical item, receiving from the user a selection that defines a qualitative link between the user and the physical item, and forwarding information about the qualitative link to an external service.

### CROSS-REFERENCE TO RELATED APPLICATION

This application claims priority to, and the benefit of, U.S. Provisional Patent Application Ser. No. 61/467,076, filed on 24 Mar. 2011, the disclosure of which is incorporated herein by reference in its entirety.

### TECHNICAL FIELD

The aspects of the present disclosure generally relate to sharing opinions about products.

### BACKGROUND ART

In World Wide Web (WWW) there are many applications where users can “like” electronic objects. For example Facebook™ includes functionality for showing a simple thumbs-up sign and sharing what you like as you stumble along the web. Also other websites like for example YouTube™ are implementing a similar functionality.

However, people still inhabit the physical reality. With regard to sharing which physical objects you like you typically call your friend, or write a review, or even just mention it in passing over dinner, in your blog, in Twitter™ or in Facebook™.

### SUMMARY

According to a first example aspect of the invention there is provided a method according to enclosed independent method claims. According to a second example aspect of the invention there is provided an apparatus according to enclosed independent apparatus claims. According to a third example aspect of the invention there is provided a memory medium according to enclosed independent memory medium claims.

Different non-binding example aspects of the present invention have been illustrated in the foregoing.

### BRIEF DESCRIPTION OF THE DRAWINGS

The aspects of the present disclosure will be described, by way of example only, with reference to the accompanying drawings, in which:

FIG. 1 shows a scenario according to an example embodiment;

FIG. 2 shows a user interface according to an example embodiment

FIG. 3A shows a flow diagram according to an example embodiment;

FIG. 3B shows a flow diagram according to an another example embodiment;

FIG. 4 shows a block diagram of an apparatus according to an example embodiment; and

FIG. 5 shows a block diagram of an apparatus according to another example embodiment.

### DETAILED DESCRIPTION

Near Field Communication (NFC) is a form of Radio Frequency Identification (RFID) technology. In one operating mode, an NFC device is an active device that can read passive RFID tags. That is, the RFID reader does not need to be part of the infrastructure. AN NFC device can operate as a passive device too. This allows various interactions between the users and their surroundings.

Following example embodiments of the present disclosure employ NFC technology. It is to be noted that depending on the implementation also other short range communication technologies, such as RFID or Bluetooth, may be employed.

In an embodiment of the present disclosure a Near Field Communication device (such as a cell phone) is used to “Like” a physical, concrete object, which has an NFC tag on it. Additionally it is possible for users to share other opinions about products. Various embodiments of the present disclosure provide users a possibility to indicate that the user likes the target item, dislikes the item, wants to have the item, owns the item, or has some other opinion about the item, or wishes to sell, loan, give or otherwise transfer the item.

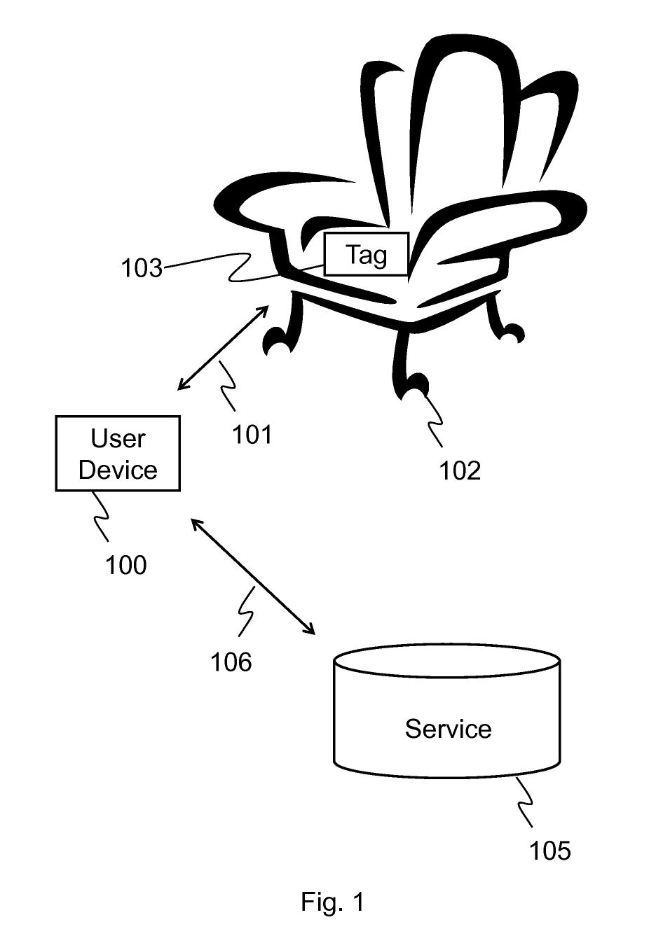

FIG. 1 shows a scenario according to an embodiment of the present disclosure. The scenario comprises a user device 100, a physical item 102 with an NFC tag 103 on it and a service 105. The user device 100 may be for example a mobile phone or some other (portable) electronic device, which comprises NFC communication capabilities. In this example the physical item 102 is a chair, but likewise the physical item could be any other physical, concrete object. The user device 100 is capable of reading information from the tag 103 over an NFC connection. The service 105 is for example an internet service and the user device 100 is capable of communicating with the service over a radio link 106.

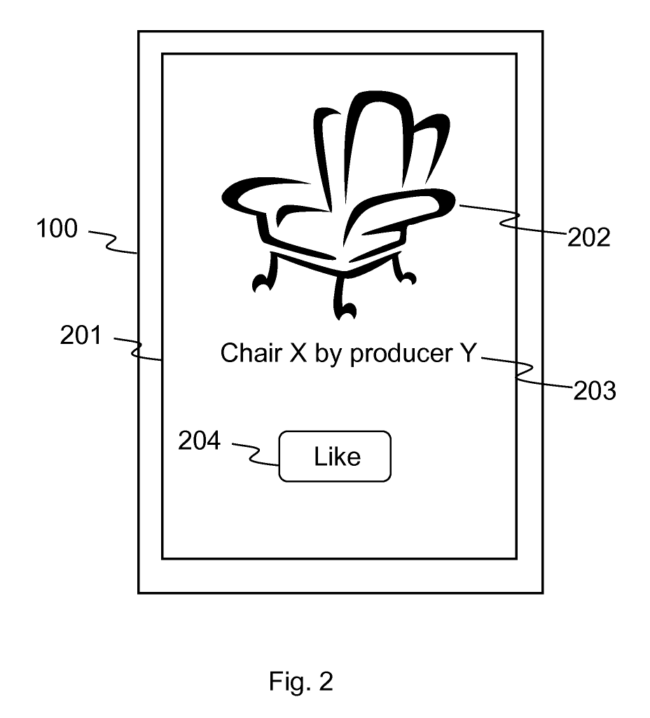

FIG. 2 shows a user interface according to an example embodiment of the present disclosure. This may be for example the user interface of the user device 100 of FIG. 1.

The user interface comprises a display 201. In the display 201, there is shown an image 202 of the chair 102 of FIG. 1, information 203 about the chair and a function button 204.

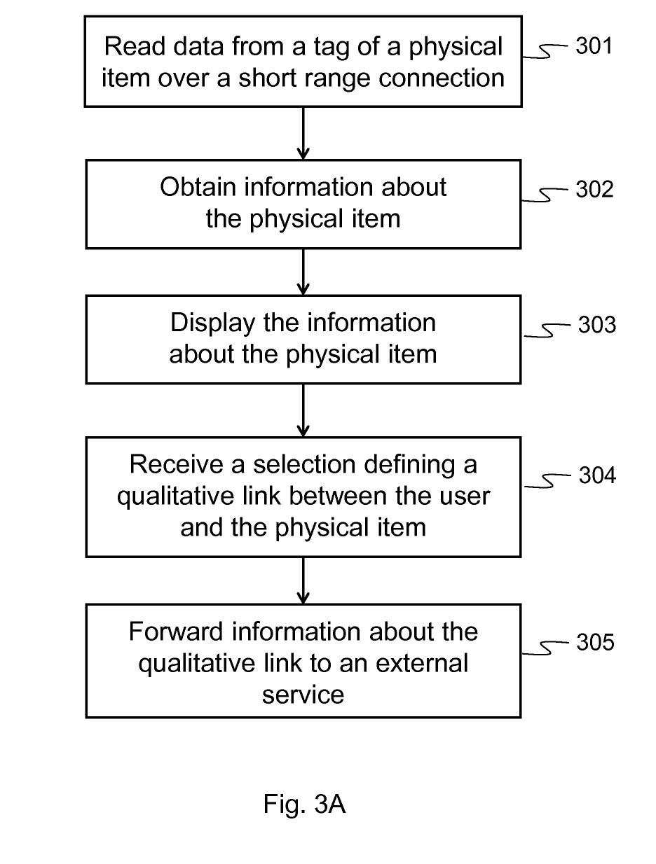

In an embodiment of the present disclosure following steps take place in the scenario of FIG. 1 and user interface of FIG. 2.
1 The user of the user device 100 sees the physical item 102 that they like.
2 The user locates the NFC tag sticker 103 on the item 102.
3 The user touches the tag 103 with the user device 100.
4 The user device 100 establishes an NFC connection with the tag 103, reads the NFC tag 103, and parses contents of the tag 103. An application in the user device 100 calculates or otherwise obtains a unique identifier for the item 102.
5 The user device 100 obtains information about the item 102 using the unique identifier. Optionally, the user device 100 contacts a backend service 105 using suitable radio communication technology and queries information from the backend service with the unique identifier. The user device receives as a response for example a description of the item 102 (possibly including multimedia such as an image or video of the item 102). The user device can also receive other information associated with the item 102, as explained with further detail with reference to FIG. 3. Alternatively, information about the item 102 may be readily available in a database or the like in the user device 100. In yet another alternative, the unique identifier may include information about the item 102. Also combinations of the alternatives are possible.
6 The user device 100 provides information about the item 102 on the display 201. For example an image 202 of the item, a description 203 of the item and a function button 204 may be displayed. In an embodiment of the present disclosure the function button 204 allows a user to announce if they like (or dislike) the item 102. In this way the user may define a qualitative relationship or link between themselves and the item 102.
7 Upon manipulation of the function button 204 (e.g. pushing the function button 204), the user device 100 sends a signal to the backend service 105, which in turn associates the user of the user device 100 with the item 102 using the qualitative relationship given (e.g. like or dislike).
8 Optionally, the backend service 105 can then share this information to Facebook™ or other social networks. In another embodiment of the present disclosure, the backend service 105 is one of the said social networks. In that case, an application running in the user device 100 sends information about the qualitative relationship to one or more social networking services.

It must be noted that the “like” button in FIG. 2 is only one example and that other qualitative relationships or links may be defined as well. For example, the user may dislike the item or announce some other opinion about the item. The user may for example announce that they want to have (for example buy or borrow) the item or that they already own the product (possibly another copy or instance of the product). By submitting this qualitative relationship with the item/product to external systems, that maintain information about products and qualitative relationships between users and the products, and/or to social networking services users can easily share their opinions about products they see.

In an embodiment of the present disclosure, more than one function buttons (or other selection possibility) are offered to the user. For example, like and dislike buttons may be displayed at the same time and the qualitative relationship or link between the user and the product is defined depending on the selection of the user.

According to some embodiments of the present disclosure the unique identifier can be:

The static UUID (Universally Unique Identifier) of the tag. In this case the backend service maintains information about which tag UUIDs belong to the same item. That is, multiple instances of the same chair type each have their own UUIDs, and all these UUIDs are associated to the respective one chair type in the backend service.

A hash code calculated from the dynamic memory content of the tag. The dynamic memory content of the tag can be defined such that all instances of the same chair type have the same dynamic memory content and therefore the same hash code. In this way, the unique identifier (the hash code) readily identifies the chair type and there is no need to match multiple UUIDs to one particular chair type. In this case, no changes are needed in the backend service or in the user device when new tags are generated.

A particular data record included in the tag. For example NDEF (NFC Data Exchange Format), URI (Uniform Resource Identifier), or Smart Poster records can be used. These can be defined the same way as the dynamic memory content above and therefore the same benefits can be obtained.

In an embodiment of the present disclosure, the unique identifier exists in a URI format, for example “thing:<uid>”, or “http://thinglink.com/thing/<uid>”.

FIG. 3A shows a flow diagram according to an example embodiment. The method can be implemented for example in the user device 100 of FIG. 1.

In phase 301 data is read from a tag of a physical item over a short range communication connection.

In phase 302 the data read from the tag is used to obtain information associated with the physical item. In an embodiment of the present disclosure an identifier for the physical item is calculated on the basis of the data read from the tag. In an embodiment of the present disclosure the data read from the tag is used as the identifier. In an embodiment of the present disclosure the identifier is used for obtaining the information associated with the physical item. In an embodiment of the present disclosure the information associated with the physical item is obtained from an information service on the basis of the identifier. In an embodiment of the present disclosure the data read from the tag is a link to an electronic source where information associated with the physical item can be found and the information is obtained from this source.

In phase 303 the information about the item is displayed on a display of the user device. In an embodiment of the present disclosure one or more function buttons are displayed at the same time or some other mechanism to make a selection is provided to a user of the user device.

In phase 304 a selection that defines a qualitative link between a user and the physical item is received from the user. In an embodiment of the present disclosure the selection is received through the one or more function buttons or some other selection mechanism mentioned above. The qualitative link may indicate that the user likes the item, dislikes the item, wants to have the item, owns the item, or some other opinion about the item.

In phase 305 information about the qualitative link is forwarded to an external service. In an embodiment of the present disclosure the information about the qualitative link comprises an identifier for the physical item defined based on the data read from the tag and a user identifier. In an embodiment of the present disclosure information about the qualitative link is shared in a social networking service.

It must be noted that above mentioned information service, external service and social networking service may be separate services or two or three of these may be included in same service.

FIG. 3B shows a flow diagram according to another example embodiment. The method can be implemented for example in the service 105 of FIG. 1.

In phase 311 an identifier associated with a physical item is received from a user device. The identifier is based on data read into the user device from a tag of the physical item over a short range communication connection. The identifier may be the data read from the tag as such or an identifier calculated on the basis of the data read from the tag.

In phase 312 information about the physical item is obtained on the basis of the identifier. The service may include for example a database from which the information is fetched. Alternatively or additionally, information may be fetched from an external place. In an embodiment of the present disclosure the identifier is a link to an electronic source where information associated with the physical item can be found and the information is obtained from this source.

The information obtained about the physical item contains, in one embodiment, one or more of pieces of information concerning the physical item or other items corresponding the physical item:

product recommendations;

user comments;

user characterizations, such as qualitative characterization of one or more categories (e.g. number of liking or disliking characterizations);

vendors or outlets; and

prices.

Any or all of the information mentioned in the preceding paragraph can be obtained from the external place or source such as a social media engine or from a server that is communicatively connected with one or more such external places or sources.

In phase 313 the information about the physical item is returned to the user device.

It must be noted that phases 312 and 313 are not mandatory. The user device may obtain the information about the physical item from some other source as well.

In phase 314 information about a qualitative link between the user of the user device and the physical item is received from the user device. In an embodiment of the present disclosure the information about the qualitative link comprises the identifier for the physical item and a user identifier. The qualitative link may indicate that the user likes the item, dislikes the item, wants to have the item, owns the item, or has some other opinion about the item, or wishes to sell, loan, give or otherwise transfer the item.

In phase 315, the received information about the qualitative link is processed in relationship to other qualitative links received previously. The processing may include for example one or more of the following: user profiling, product profiling, statistical analysis, matching/grouping users with the same or similar qualitative links or the like.

It must be noted that in some cases the phases 311 and 314 may be performed at the same time. That is, both the identifier associated with the physical item and the qualitative link between the user and the physical item may be transmitted in the same message. In that case there is no need to transmit the identifier separately.

In an embodiment of the present disclosure information about the qualitative link is shared in a social networking service.

In an embodiment of the present disclosure the service maintains records of received qualitative links between users and physical items. In an embodiment of the present disclosure the maintained records about the qualitative links are used for user profiling. Further actions may be taken based on this profiling. For example,

Users that like or want to have certain item may be provided with additional information about the item and availability of the item.

Additional information is not sent to users that dislike certain item.

Producers may make decisions about whether to start or continue producing certain item based on user liking or disliking the item.

Clearly, various other actions can be taken as well.

Embodiments of the present disclosure may be implemented in software, hardware, application logic or a combination of software, hardware and/or application logic. The software, application logic and/or hardware may reside on a server of a service provider (such as the service 105 of FIG. 1).

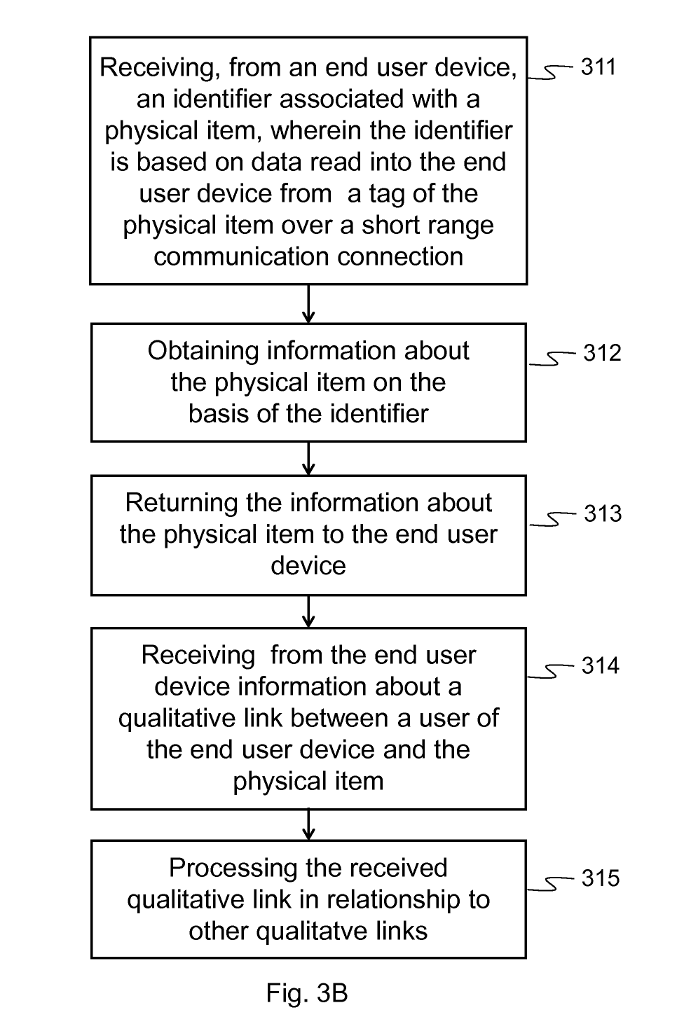

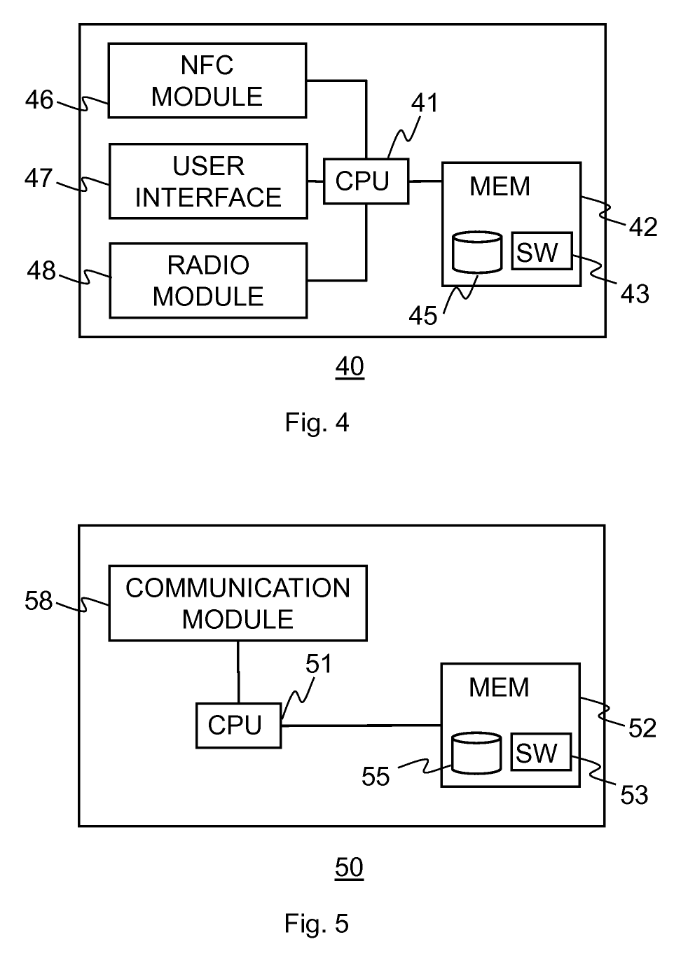

In an example embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer or some other electronic device, with some examples of such devices described and depicted in FIGS. 4 and 5 below. The computer-readable medium may be a digital data storage such as a data disc or diskette, optical storage, magnetic storage, or opto-magnetic storage. The computer-readable medium may be formed into a device without other substantial functions than storing memory or it may be formed as part of a device with other functions, including but not limited to a memory of a computer, a chip set, and a sub assembly of an electronic device.

FIG. 4 shows an example block diagram of an apparatus 40 according to certain example embodiments of the present disclosure. The apparatus 40 may be for example the user device 100 of FIG. 1. The apparatus 40 may be a mobile phone, a tablet computer or some other portable/handheld electronic device.

The apparatus 40 comprises at least one memory 42 configured to store computer program code (or software) 43. The memory 42 may comprise a database 45, but this is not mandatory. The apparatus 40 further comprises at least one processor 41 for controlling the operation of the apparatus 40 using the computer program code 43. Additionally the apparatus 40 comprises a near field communication module 46, a user interface module 47 and a radio communication module 48.

The at least one processor 41 may be a master control unit (MCU). Alternatively, the at least one processor 41 may be a microprocessor, a digital signal processor (DSP), an application specific integrated circuit (ASIC), a field programmable gate array, a microcontroller or a combination of such elements. FIG. 4 shows one processor 41, but the apparatus 40 may comprise a plurality of processors 41.

The at least one memory 42 may be, for example, random access memory, flash memory, hard disk, hard disk array, optical storage, memory stick, memory card and/or magnetic memory. The apparatus 40 may comprise a plurality of memories. The memory 42 may be constructed as a part of the apparatus 40 or it may be inserted into a slot, port, or the like of the apparatus 40 by a user. The memory 42 may serve the sole purpose of storing data, or it may be constructed as a part of an apparatus serving other purposes, such as processing data. The database 45 may be for example an SQL-database.

The near field communication module 46 may be also some other short distance communication module such as an RFID module.

The user interface module 47 may comprise circuitry for receiving input from and providing output to a user of the apparatus 40, e.g., via a keyboard, a display, a touch screen, or a microphone/loudspeaker for example.

The radio module 48 may be, e.g., a WLAN, Bluetooth, GSM/GPRS, CDMA, WCDMA, or LTE (Long Term Evolution) radio module. The radio module 48 may be integrated into the apparatus 40 or into an adapter, card or the like that may be inserted into a suitable slot or port of the apparatus 40. The radio module 48 may support one radio interface technology or a plurality of technologies. FIG. 4 shows one radio module 48, but the apparatus 40 may comprise a plurality of radio modules 48.

The at least one processor in combination with the computer program 43 and the NFC, user interface and radio modules 46-48 is configured to implement at least some features of various embodiments of the present disclosure described above.

A skilled person appreciates that in addition to the elements shown in FIG. 4, the apparatus 40 may comprise other elements, such as batteries, microphones, displays, as well as additional circuitry such as input/output (I/O) circuitry, memory chips, and the like.

FIG. 5 shows an example block diagram of an apparatus 50 according to certain example embodiments of the present disclosure. The apparatus 50 may be implemented on a general purpose computer or a server for example and it may provide the service 105 of FIG. 1.

The apparatus 50 comprises at least one memory 52 configured to store computer program code (or software) 53. The memory 52 may comprise a database 55, but this is not mandatory. The apparatus 50 further comprises at least one processor 51 for controlling the operation of the apparatus 40 using the computer program code 53. Additionally the apparatus 50 comprises a communication module 58.

The at least one processor 51 may be a master control unit (MCU). Alternatively, the at least one processor 51 may be a microprocessor, a digital signal processor (DSP), an application specific integrated circuit (ASIC), a field programmable gate array, a microcontroller or a combination of such elements. FIG. 5 shows one processor 51, but the apparatus 40 may comprise a plurality of processors 51.

The at least one memory 52 may be, for example, random access memory, flash memory, hard disk, hard disk array, optical storage, memory stick, memory card and/or magnetic memory. The apparatus 50 may comprise a plurality of memories. The memory 52 may be constructed as a part of the apparatus 50 or it may be inserted into a slot, port, or the like of the apparatus 50 by a user. The memory 52 may serve the sole purpose of storing data, or it may be constructed as a part of an apparatus serving other purposes, such as processing data. The database 55 may be for example an SQL-database. The database may be used for storing information about physical items and associated unique identifiers according to various embodiments of the present disclosure. Additionally or alternatively the database may be used for storing information about qualitative relationships between physical items and users.

The communication module 58 may be for example a radio communication module 48, e.g., a WLAN, Bluetooth, GSM/GPRS, CDMA, WCDMA, or LTE (Long Term Evolution) radio module, or a fixed line communication module, e.g. an Ethernet or LAN communication module. The communication module 58 may be integrated into the apparatus 50 or into an adapter, card or the like that may be inserted into a suitable slot or port of the apparatus 50. The communication module 58 may support one communication technology or a plurality of technologies. FIG. 5 shows one communication module 58, but the apparatus 50 may comprise a plurality of communication modules 58.

The at least one processor in combination with the computer program 53 and the communication module 58 is configured to implement at least some features of various embodiments of the present disclosure described above.

A skilled person appreciates that in addition to the elements shown in FIG. 5, the apparatus 50 may comprise other elements, such as batteries, microphones, displays, as well as additional circuitry such as input/output (I/O) circuitry, memory chips, and the like.

By means of the liking mechanism as defined in various embodiments of the present disclosure people can easily share which physical objects they like in a similar way that they can share liking electronic objects. Liking of physical objects is easy as user no longer needs to make the connection between the physical object and the chosen social network on their own. In other words, people can associate their likes with physical objects in a clear and concise manner.

Other benefits achievable in various embodiment of the present disclosure include:

It is not necessary for the object to exist in the database—associations are manipulated using the unique identifiers. Normally, the association between an object and what it represents are done in a database. For example, in a shop inventory each item is associated with a barcode to a database entry, exactly detailing that number 1234678 corresponds to a ketchup bottle. Whereas, in an example embodiment one can establish a relationship without recognizing what number 1234678 really means: for example, if two persons register their deep like of product 1234678, it is not necessary to know that it is a bottle of ketchup to form a relationship between the two persons.

As the unique identifiers could be URIs (Uniform Resource Identifier), it would make possible to dereference them even if the item itself would contain no URI, or the URI would be obsoleted. If the unique identifiers are formed in the form of an URI (e.g. “thing:1234678”, or “www.thinglink.com/thing/1234678”) it is not necessary for the object itself to have a web page (www.ketchup.com). It is sufficient for related service to create a dereferenceable URL (Uniform Resource Locator) for the object so that people can for example describe and discuss the object.

Various social media services can be associated with the object and made readily available to user of the apparatus 40 on accessing the object with the apparatus 40.

Utilization of the dynamic memory content contained in the tags makes it possible that multiple physical items that have NFC tags would automatically encode to the same unique identifiers. Even if the tag UUID would change, the dynamic content may remain the same and thereby the unique identifier will be the same. In this way there is no need to maintain records of which UUIDs are associated with certain item.

Various embodiments have been presented. It should be appreciated that in this document, words comprise, include and contain are each used as open-ended expressions with no intended exclusivity.

The foregoing description has provided by way of non-limiting examples of particular implementations and embodiments of the present disclosure a full and informative description of the best mode presently contemplated by the inventors for carrying out the present disclosure. It is however clear to a person skilled in the art that the present disclosure is not restricted to details of the embodiments presented above, but that it can be implemented in other embodiments using equivalent means or in different combinations of embodiments without deviating from the characteristics of the present disclosure. It is also noted that the above embodiments are used merely to explain selected aspects or steps that may be utilized in implementations of the present disclosure. Some features may be presented only with reference to certain example embodiments of the present disclosure. It should be appreciated that corresponding features may apply to other embodiments as well.

Furthermore, some of the features of the above-disclosed embodiments of this present disclosure may be used to advantage without the corresponding use of other features. As such, the foregoing description shall be considered as merely illustrative of the principles of the present disclosure, and not in limitation thereof. Hence, the scope of the present disclosure is only restricted by the appended patent claims.

We claim:

1. A method comprising:
reading data from a tag of a physical item over a short range communication connection,
using the data read from the tag to obtain information associated with the physical item,
displaying to a user the obtained information associated with the physical item,
receiving from the user a selection that defines a qualitative link between the user and the physical item, and
forwarding information about the qualitative link to an external service.

2. The method of claim 1, further comprising
calculating an identifier for the physical item on the basis of the data read from the tag, and
using the unique identifier for obtaining information associated with the physical item.

3. The method of claim 1, further comprising
obtaining information associated with the physical item from an information service.

4. The method of claim 3, wherein the information associated with the physical item comprises at least one of: product recommendations relating to the physical item; vendors or outlets for the physical item; user comments; user characterizations, vendors or outlets; and prices.

5. The method of claim 1, wherein the information about the qualitative link comprises an identifier for the physical item defined based on the data read from the tag and a user identifier.

6. The method of claim 1, further comprising
sharing information about the qualitative link in a social networking service.

7. The method of claim 1, further comprising
displaying to the user one or more function buttons for making the selection.

8. The method of claim 1, wherein the link is the user liking the item.

9. A method comprising:
maintaining records of qualitative links between users and physical items,
receiving, from a user device, an identifier associated with a physical item, wherein the identifier is based on data read into the user device from a tag of the physical item over a short range communication connection,
receiving, from the user device, information about a qualitative link between the user of the user device and the physical item, and
processing the received information about the qualitative link in relationship to the maintained records.

10. The method of claim 9, further comprising
in response to receiving the identifier associated with the physical item, obtaining information about the physical item on the basis of the identifier, and
returning the obtained information about the physical item to the user device.

11. The method of claim 10, wherein the information associated with the physical item comprises at least one of: product recommendations relating to the physical item; vendors or outlets for the physical item; user comments; user characterizations, vendors or outlets; and prices.

12. The method of claim 9, further comprising
sharing information about the qualitative link in a social networking service.

13. The method of claim 9, wherein said processing comprises
using the maintained records about the qualitative links for user profiling.

14. The method of claim 9, wherein the qualitative link is the user liking the item.

15. The method of claim 9, wherein the link is the user disliking the item.

16. An apparatus comprising:
at least one processor; and
at least one memory including computer program code;
the memory and the computer program code in combination with the processor, are configured to cause the apparatus to perform:
reading data from a tag of a physical item over a short range communication connection,
using the data read from the tag to obtain information associated with the physical item,
displaying to a user the obtained information associated with the physical item,
receiving from the user a selection that defines a qualitative link between the user and the physical item, and
forwarding information about the qualitative link to an external service.

17. An apparatus comprising:
at least one processor; and
at least one memory including computer program code;
the memory and the computer program code in combination with the processor, are configured to cause the apparatus to perform:
maintaining records of qualitative links between users and physical items,
receiving, from a user device, an identifier associated with a physical item, wherein the identifier is based on data read into the user device from a tag of the physical item over a short range communication connection,
receiving, from the user device, information about a qualitative link between the user of the user device and the physical item, and
processing the received information about the qualitative link in relationship to the maintained records.

18. The apparatus of claim 17, wherein the memory and the computer program code in combination with the processor, are configured to cause the apparatus to return to the user device information associated with the physical item comprising at least one of: product recommendations relating to the physical item; vendors or outlets for the physical item; user comments; user characterizations, vendors or outlets; and prices.

19. A computer readable medium embodying computer executable program code configured to be executed by a processor of an apparatus, to cause the apparatus to perform:
reading data from a tag of a physical item over a short range communication connection,
using the data read from the tag to obtain information associated with the physical item,
displaying to a user the obtained information associated with the physical item,
receiving from the user a selection that defines a qualitative link between the user and the physical item, and
forwarding information about the qualitative link to an external service.

20. A computer readable medium embodying computer executable program code configured to be executed by a processor of an apparatus, to cause the apparatus to perform:
maintaining records of qualitative links between users and physical items,
receiving, from a user device, an identifier associated with a physical item, wherein the identifier is based on data read into the user device from a tag of the physical item over a short range communication connection,
receiving, from the user device, information about a qualitative link between the user of the user device and the physical item, and
processing the received information about the qualitative link in relationship to the maintained records.
